(19) United States
(12) Patent Application Publication
(10) Pub. No.: US 2026/0211435 A1
(43) Pub. Date: Jul. 23, 2026

(54) AN ARRANGEMENT FOR CONTROLLING TEMPERATURE PROFILE OF A TRANSFERRING DEVICE AND A METHOD THEREOF

(71) Applicant: SPINNOVA OYJ, Jyväskylä (FI)

(72) Inventors: Arttu PELTONEN, Jyväskylä (FI); Pasi SELENIUS, Jyväskylä (FI); Markku KATAJA, Jyväskylä (FI); Niklas KNUUTILA, Jyväskylä (FI); Juha SALMELA, Jyväskylä (FI)

(21) Appl. No.: 19/144,390

(22) PCT Filed: Dec. 15, 2023
(86) PCT No.: PCT/FI2023/050703

§ 371 Date: Jun. 27, 2025

(30) Foreign Application Priority Data
Dec. 30, 2022 (FI) 20226185

(51) Int. Cl. G05D 23/19; F26B 3/20

(52) U.S. Cl. CPC G05D 23/193; F26B 3/20

(57) ABSTRACT

An arrangement that includes a transferring device for receiving material to an input area of the transferring device from a material output and transferring the material in multiple lines from the input area to an output area of the transferring device in a first direction. The material is heated so to provide drying of the material during the transportation. The arrangement includes a cooling agent providing device to provide cooling agent to at least one first portion of at least one first line of the transferring device, the one first portion of the one first line having no material or having less material than at least one second portion of the at least one first or one second line, in order to control the temperature profile of the transferring device in a predetermined manner.

### TECHNICAL FIELD OF THE INVENTION

The invention relates to an arrangement and a method for controlling a temperature profile of a transferring device, such as a belt conveyor for transferring material between an input and output. In particular, the invention relates to controlling the temperature profile of such a transferring device, which is used both for transferring and heating, advantageously also drying the material to be transferred.

### BACKGROUND OF THE INVENTION

Different kinds of transferring devices are used for transferring material between two ends, like input and output areas. Few examples of the transferring devices are belts, belt conveyors or rotating cylinders, for example. In some applications the transferring device is also used for heating and/or drying the material transferred, where the transferring device receives wet material in the input area, whereafter the wet material is dried during transportation and before the output area of the transferring device. The material may be e.g. wet filaments received from multiple outputs, such as from multiple nozzles or nozzle groups, for example. In addition, in some applications the material may be sometimes received unevenly to a surface of the transferring device. For example, some of the nozzles or even nozzle groups or other output devices may be out of use or blocked or functioning insufficiently, whereupon no or less material is received from those nozzles or even nozzle groups or other output devices, which may cause unwanted effects to the transferring device.

There are some disadvantages related to the known transferring devices especially used for heating and/or drying the material transferred, namely if some of the outputs, such as nozzles or even nozzle group is out of use or blocked or working insufficiently, no material or less material is received by the transferring device from those outputs, nozzles or nozzle group(s), whereupon e.g. the temperature of the transferring device on those portions with no or less material will rise. The rising temperature has numerous unwanted effects for the transferring device and its structures, such as a thermal expansion of the structures of the transferring device, such as longitudinal thermal expansion the belt conveyor. When the temperature of the belt, for example, is rising, the length of the belt increases at the point or area having no or less material, whereupon due to the increased locational length of the belt, the moving belt will slip around supporting rollers or drift away from a center line or longitudinal axis of the belt due to forces caused by the thermal expansion. Typically, the forces caused are asymmetric in relation to the longitudinal axis of the belt, whereupon the drifting may occur be in a lateral direction, so in perpendicular to direction of travel of the belt conveyor). This is the case in particular when the area having no or less material is not exactly at the longitudinal axis of the belt. In addition, it is to be noted that the drifting is typically towards the warmer portion or side of the belt.

In addition, unwanted changes in the temperature profile of the transferring device may cause structural loads to the transferring device and its supporting structures, such as rollers supporting and driving e.g. the belt conveyor. Typically, when the temperature profile of the transferring device changes, some of the supporting rollers does not support the transferring device anymore, whereas the other rollers need to carry extra load.

It is to be noted that in some applications the transferring device must be initialized and run up before it can be receive the material. For example, the transferring device must be heated beforehand to some certain temperature so that it is ready for receiving wet material and heat and dry it exactly withing a certain time or travel. The heating and drying the wet material during transporting is a challenging task, namely when the wet material is started to be received on the surface of the transferring device, it will absorb thermal energy from the transferring device and thus cause cooling of the surface. The cooling is typically a thermal shock to the structure of the transferring device, causing rapid thermal expansions (or shrinkage) and thus loads to the structures. Again, it will be a challenging task to raise the temperature back to the desired one, at least with quick response time, because the mass of the material as well as the transferring device cause delay and again waste of energy and material before the desired level is achieved. Further, also humidity of an environment of the transferring device changes due to the temperature changes of the transferring device because the drying effect of the transferring device changes and thus evaporated moisture from the material to the environment changes as a function of the temperature of the transferring device. Also, during heating the transferring device back to the desired temperature, the drying effect of the transferring device as well as the evaporated moisture from the material to the environment change. In an optimal state both the temperature and the humidity should be and remain essentially constant.

### SUMMARY OF THE INVENTION

An object of the invention is to alleviate and eliminate the problems relating to the known prior art. Especially the object of the invention is to provide an arrangement and method for controlling a temperature profile of a transferring device, such as a belt conveyor for transferring material between an input and output. In particularly, the object of the invention is to present a solution so that the temperature profile of the transferring device can be maintained as a desired one even if there are changes in the material quantity or quality during the process on the transferring device. In addition, the object of the invention is to present a solution so that an initialization and start up of the transferring device can be done smoothly and so that receiving of the material to be transferred and heated and/or dried by the transferring device would not cause any essential changes to temperature of the transferring device and its ability to heat and/or dry the material.

The object of the invention can be achieved by the features of independent claims.

The invention relates to an arrangement for controlling a temperature profile of a transferring device according to claim 1. In addition, the invention relates to a method for controlling a temperature profile of a transferring device according to claim 16.

The invention relates to an arrangement for controlling a temperature profile of a transferring device. The transferring device is configured to receive material to an input area on a surface of the transferring device from multiple material outputs and transfer the material from the input area to an output area of the transferring device in a first direction. The transferring device may be e.g. a belt conveyor or a rotating cylinder, as an example, but not limiting to those only. In typical applications the material is wet material, which must be heated and/or dried during the transportation by the transferring device. The material is for example wet filaments provided from wet suspension. The material outputs may be implemented e.g. by nozzles, which are configured to feed the wet filaments to the first area of the transferring devices. The filaments are typically arranged into multiple lines due to multiple nozzles, or due to multiple nozzle bundles. According to an example, the arrangement may comprise e.g. 5 nozzle bundles and one nozzle bundle comprise about 700 nozzles. However, this is just an example, and the invention is not limited to these numbers, but numbers of nozzles as well as nozzle bundles can naturally vary depending on the needs and other parameters and configurations of the system.

According to an example the material is configured to be heated and dried during the transportation. The heating can be implemented e.g. by heating devices positioned above the transferring device heating the material directly. According to another example the transferring device can be heated by the heating devices so that the transferring device then transfers heat to the material during the transportation. In this example an outer surface of the transferring device is heated to higher temperature than the material received in order to achieve the drying effect to the material by the surface of the transferring device. The outer surface is the surface which is faced against the material received. It is to be noted that the arrangement may also comprise both types of the heating configurations, so the transferring devices heating the material directly above and also transferring devices heating the surface of the transferring device receiving and transferring the material. In addition, it is to be noted that in both cases an area of the transferring device having no or less material than another area, will be get warmer than other area with full load of material, thereby causing disadvantages discussed elsewhere in this document.

According to an embodiment of the invention and in order to solve the problems discussed above, the arrangement is provided advantageously by at least one cooling agent providing device to control the temperature profile of a transferring device in a predetermined manner. The arrangement may be configured to keep the temperature profile in a desired and essentially constant level or alternatively to provide a certain temperature gradient e.g. locally either in the first direction and/or in a second direction being perpendicular to the first direction. For example, it might be desired to have a local temperature transition e.g. to cause a sharp environmental change to the material on the transferring device, such as cooling the material at a certain point quickly, like just before the output area in order to facilitate a detaching of the material from the surface of the transferring device.

The cooling agent providing device is advantageously configured to provide the cooling agent on the surface of the transferring device. The surface may be either inner and/or outer surface. The cooling agent providing device may be for example a spraying device for spraying the cooling agent, but naturally also other suitable types of cooling agent providing devices can be used.

According to an embodiment of the invention the cooling agent is provided to at least one first portion of at least one first line of the transferring device, wherein the one first portion of the one first line does not have material or has less material than at least one second portion of the at least one first or one second line. Alternatively, or in addition to, the temperature of one first portion of the one first line may be higher or expected to increase higher than temperature at least one second portion of said at least one first or one second line, whereupon the cooling agent can be provided to that at least one first portion of the at least one first line of the transferring device in order to control the temperature profile of the transferring device in a predetermined manner.

As an example, when some nozzles are blogged and no or less material is fed by those nozzles onto the transferring device, the cooling agent is provided to those areas of the transferring device in order to achieve heat transfer from the transferring device to the provided cooling agent. The heat transfer [J] should be essentially equivalent to that would have been by the full material load so to the heat transfer from the transferring device to the full material load on the transferring device. This has clear advantages, namely the temperature of the transferring device can be kept essentially constant or in a desired level and harmful effects do not exist. When the blockage is opened, the feeding of the cooling agent can be decreased and stopped, most advantageously at the same pace and at the same time.

According to an example, the arrangement is initialized in a run up process by increasing the temperature of the transferring device to a desired level, and adjusting also other parameters, such as speed of the transferring device, like a belt conveyor or a rotating cylinder. In the run up and initialization process there is no material on the transferring device yet. One of the next steps is to start the material feeding onto the surface of the transferring device by the nozzles or other output devices. When the material, so typically the wet filaments for example, is fed onto the surface of the transferring device, it will absorb thermal energy from the transferring device and thus cause a drop of the temperature of the transferring device. At the same to providing of the cooling agent is decreased and stopped so that the total heat transfer from the transferring device to the cooling agent at first and then to the material transferred and dried remains essentially constant.

In order to avoid the temperature changes due to the material to be received, the cooling agent is provided according to the invention onto the surface of the transferring device instead of the material. The cooling agent is provided onto the transferring device before or during the initialization, or at least before the material is fed. By providing the cooling agent instead of the material, the temperature can be raised to the desired level and the system kept in stable state.

Now, when the material is started to be fed onto the surface of the transferring device, amount of the provided cooling agent is reduced and finally stopped, when the full feeding of the material is achieved. It is to be noted that at the initialization when there is no material, the quantity and temperature of the provided cooling agent should be such that it absorbs essentially the same amount of thermal energy from the transferring device as the full material load fed onto the surface would do, so the heat transfer from the transferring device is same and constant whether there is no material (then the cooling agent is provided) or full material load (no cooling agent provided). In addition, when the material is started to be fed onto the surface of the transferring device, the reduction of the cooling agent should be so that the combined or total heat absorbing effect of both the reduced amount of the cooling agent and the material fed onto the surface of the transferrin device is essentially same, as was either by cooling agent provided in the initialization process (and with no material) or as would be with the full load of material (and with no cooling agent). The heat transfer from the transferring device must be essentially constant, so for example in the initialization process due to just the cooling agent (and no material) the heat transfer is e.g. 100 unit, during the receiving just full load of the material (and no cooling agent) again the same 100 unit, and in the intermediate state the sum of the heat transfer due to partial load of the material and partial load of the cooling agent should be again the same 100 unit.

Thus, the heat transfer from the transferring device is kept essentially constant regardless of whether there is material on the surface of the transferring device or cooling agent is provided instead of the material or of there is a certain intermediate state during run up and both the cooling agent and material are partially present.

According to the invention it is possible to start and stop or vary the quantity of the material to be fed onto the surface of the transferring device without need to adjust the temperature and wait the thermal stabilization of the arrangement.

The cooling agent providing device may be for example a spraying device for spraying water. It is to be noted that many kinds of cooling agents can be used, such as water or water-based substance, pressurized air, liquid nitrogen, chemical active ingredient, or other coolant or fluid having suitable cooling effect. Further, the cooling agent may advantageously be easily evaporating and non-contaminating, whereupon its effect can be easily controlled, for example when the cooling effect should be end. In addition, the cooling agent may, in some embodiments, comprise additives depending on the needs, such as substance having effect for changing friction, like release chemical for changing friction e.g. between the structural parts of the transferring device, such as between the belt conveyor and supporting rollers supporting or drums the belt conveyor or between the surface of the transferring device and the material received so that the material will detach from the surface easier.

According to an embodiment, the cooling is happened via evaporation of the cooling agent on the surface of the transferring device. The control of the temperature profile of the transferring device is this advantageously implemented via evaporation of the cooling agent in a predetermined manner so to achieve a desired temperature for the transferring device.

In addition, the cooling agent providing devices can be arranged in different positions and also to provide the cooling agent in and to different locations of the transferring device, such as to the at least one first portion of at least one first line of the transferring device at said input area, between said input and output areas, before said input area and/or after said output area in said first direction.

The present invention offers advantages over the known prior art, such as providing a solution to maintain the temperature profile of the transferring device as a desired one even if there are changes in the material quantity or quality received onto the transferring device during the process. In particular, the present invention offers also solution for an initialization of the transferring device so that receiving of the material to be transferred and heated and/or dried by the transferring device does not cause any essential temperature changes or temperature shocks to the transferring device, as well as essentially no changes to humidity of the environment of the arrangement. In addition, according to the invention the transferring device is in a desired temperature right at and from the beginning of the heating and/or drying process of the material to be received and transferred, whereupon there are no time consuming and challenging adjustments of the transferring device at the start or run up, when material is started to be received. Thus, also energy, time and also material is saved, because the transferring device can be operated in an optimal way just right from the beginning of the process.

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIGS. 1-2 illustrate a side view of an exemplary arrangement for controlling a temperature profile of a transferring device according to an advantageous embodiment of the invention,

FIGS. 3-6 illustrate a top view of an exemplary arrangement for controlling a temperature profile of a transferring device according to an advantageous embodiment of the invention,

FIGS. 7-10 illustrate an example view of an initialization and start up process of an exemplary transferring device according to an advantageous embodiment of the invention, and

FIG. 11 illustrate a principle of another exemplary arrangement for controlling a temperature profile of a transferring device according to an advantageous embodiment of the invention.

### DETAILED DESCRIPTION

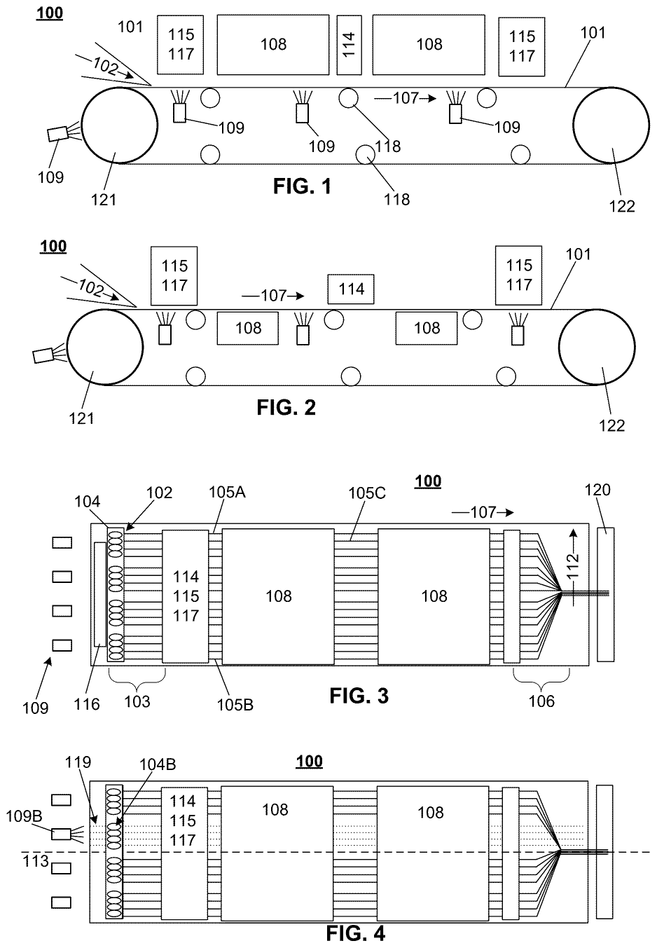

FIGS. 1-2 illustrate a side view and FIGS. 3-6 a top view of an exemplary arrangement 100 for controlling a temperature profile of a transferring device 101 according to an advantageous embodiment of the invention, where the transferring device 101 is configured in particular to receive wet filaments 102 (as the material) to an input area 103 on a surface of the transferring device from multiple nozzles 104. In addition, the transferring device 101 transfers the filaments from the input area 103 to an output area 106 of the transferring device in a first direction 107. The transferring device 101 in these examples is a belt conveyor 101, which is supported by supporting rollers 118 and end rollers, or by a driving drum 121 and tension drum 122, where the driving drum 121 is used for driving the belt conveyor 101 and the tension drum 122 can be used for adjusting the tension of the belt conveyor 101 The arrangement 100 comprises also heating devices 108 for heating and thus drying the filaments during transportation. The heating devices 108 can be arranged above the belt conveyor 101 (as in FIG. 1.) heating directly the filaments on the transferring device, and/or the heating devices 108 can be arranged so that they heat first the transferring device 101 (as in FIG. 2.) and the transferring device 101 then transfers heat to the filaments. Anyway, it should be noted that even if the heating devices 108 above the belt conveyor 101 are used, also the temperature of the surface and the structure of the belt conveyor would rise, if there are no filaments or the quantity of filaments is less the desired or less than in another area of the belt conveyor.

The arrangement comprises also at least one cooling agent providing device 109 to provide the cooling agent 119 on the surface of the belt conveyor 101, thus controlling the temperature profile of the belt conveyor 101 in a predetermined manner. The cooling agent providing devices 109 can be arranged to provide the cooling agent to an outer surface of the belt conveyor 101 and/or to an inner surface of the belt conveyor 101, as can be seen e.g. in FIGS. 1, 2 and 7.

As can be seen e.g. in FIGS. 3-6, the filaments are received from multiple nozzles 104, whereupon the filaments form multiple lines 105A, 105B, 105C on the surface of the belt conveyor 101. FIG. 4 illustrates an example, where the nozzles (or the nozzle bundle) 104B do not feed the filaments, whereupon the cooling agent providing device 104B is activated to provide cooling agent 119. The cooling agent 119 is provided advantageously to that area of the belt conveyor 101, which would receive and transfer the filaments fed by the nozzles (or the nozzle bundle) 104B. As it can be seen, the other nozzles (or nozzle bundles) are functioning properly and thus there is no need for the cooling agent to those areas.

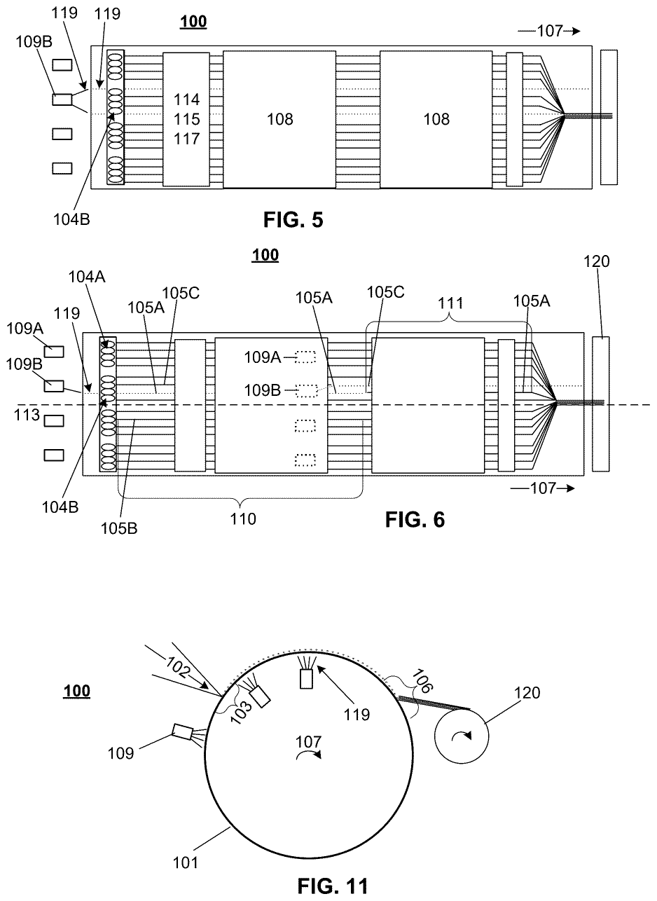

As can be seen in an exemplary FIG. 5., couple of nozzles 104B are not providing the filaments, whereupon the cooling agent 119 is provided only to the corresponding areas or lines. In addition, as can be seen in FIG. 6, a filament line 105A is stopped to fed and thus there is no filament in a first portion 110 of the of the first line 105A of the belt conveyor 101. Still the rest of the filament line 105A can be seen in a second portion 111 of the first line 105A on the belt conveyor 101 being transferred to the first direction 107. Thus, according to an advantageously embodiment of the invention the cooling agent 119 is provided to at least one first portion 110 of at least one first line 105A of the belt conveyor 101, wherein the one first portion 110 of the one first line 105A does not have material or has less material than at least one second portion 111 of the at least one first 105A or one second line 105B.

Again, as it can be seen in an exemplary FIG. 6., the filament to the third line 105C is started to be fed and the first portion 110 of the of the third line 105C of the belt conveyor 101 already comprises the filament. Thus, according to the advantageously embodiment of the invention the providing of the cooling agent 119 is stopped so that the first portion 110 of the third line 105C of the belt conveyor 101 does not have the cooling agent 119 but just the filament 105C. However, the cooling agent has been provided so that the second portion 111 of the third line 105C on the belt conveyor 101 still has the cooling agent but not the filaments yet.

The second or third line 105C may be next to the first line 105A or the second line 105B may also locate opposite of a longitudinal center line 113, for example symmetrically opposite of the longitudinal center line 113. According to an example, the second line 105B can be used as a reference line for which a heat transfer or delivery to the material corresponding a full reception of material amount can determined and used that calculation to determine the quantity and temperature of the cooling agent to be provided to the first line so that the cooling effect of the provided cooling agent corresponds essentially the cooling effect of the 100 % material feed on the reference line and thus the arrangement is in a balance in relation to the longitudinal center line 113.

According to an embodiment the arrangement may comprise number of cooling agent providing devices 109. The cooling agent providing devices 109 can be arranged parallel, as is the case e.g. in FIG. 5, or sequentially in the first direction 107, as is the case e.g. in FIGS. 1, 2 and 6. Thus, by suitably controlling the cooling agent providing devices 109 arranged in parallel and/or sequentially, the temperature profile of the transferring device 101 can be controlled in the first direction 107 and/or in the second direction 112 being perpendicular to the first direction 107.

According to an example, the arrangement 100 advantageously comprises a control unit 114 for controlling the devices of the arrangement advantageously based on read parameters and/or parameters predetermined, input, or set beforehand. The control unit 114 is for example configured to control the operations of the cooling agent providing device 109 and in particular determine and control a mass flow and/or temperature of the cooling agent 119 provided by the cooling agent providing device 109. The control unit 114 may also determine the quantity and/or temperature of the mass flow of the cooling agent 119 needed to compensate a shortage of the heat transfer due to shortage of the filaments on a certain area or length of a certain line of the belt conveyor 101. The control unit may for example determine the amount of the heat energy [J], which would be transferred from a certain portion of the belt conveyor 101, if that portion would have received the filaments, and based on that (amount of the heat energy [J]) determine the amount and/or temperature of the cooling agent to be provided on that area, and based on that control the operation of cooling agent providing device 109 correspondingly, such as adjust temperature and/or mass flow of the cooling agent. In addition, the control unit may also determine the portion of the belt conveyor 101, where the cooling agent is needed and thereby control suitable cooling agent providing devices 109. Further, the control unit 114 may also be provided with a certain desired temperature profile of the belt conveyor 101, whereupon the control unit 114 may determine the amounts and/or temperatures for one or more cooling agent providing devices 109 (cooling agent 119) so that the cooling agent 119 provided by them will cause such heat transfer from the belt conveyor 101 that the desired temperature profile is achieved. It is to be noted that the temperature profile can be controlled both in the first direction 107 and second direction 112, especially when the arrangement can provide cooling agent both in the first and second directions 107, 112. In addition, it is to be noted that the temperature can be lowered by the cooling agent from the initial temperature of the belt conveyor 101.

According to an embodiment, the arrangement may comprise a first detecting device 115 for detecting an existence or amount of the filaments in the multiple lines 105A, 105B, 105C on the belt conveyor 101, whereupon the control unit 114 may then determine the amount and/or temperature of the cooling agent and thereby control the operation of the cooling agent providing device 109. It is to be noted that for example the amount may be varied between 0-100% in order to respond also to situations where only a certain portion of the filaments on the belt conveyor 101 are missing. In addition, according to an embodiment, the cooling agent providing device 109 may comprise more than one input to thus also being able to receive more than one cooling agent, whereupon the control unit may also control the input so that the cooling agent providing device 109 or separate cooling agent providing devices 109 can receive and provide different cooling agents or mixtures of different cooling agents to achieve broader variety to the cooling effects, such as pure water to some portions and more evaporating to another portion, or two different cooling agents different portions, where the two cooling agents have different heat capacities and thus different cooling effects. The first detecting device 115 may be e.g. a camera, capacitive sensor or the like suitable for determining existence or amount of the material, such as filaments, on the belt conveyor 101.

In addition, the arrangement may also comprise a second detecting device 116 for detecting an existence of the nozzle bundle in the case the nozzles are arranged in the bundles. Thus, the second detecting device may just determine whether the nozzle bundle is its position or not and output data relating to the existence of the nozzle bundle to the control unit 114. The control unit 114 can then, based on said data, control the cooling agent providing device 109 to provide the cooling agent to the portion of the belt conveyor 101 corresponding the nozzle bundle. Then, when the nozzle bundle is set on its position, the second detecting device detects this and outputs signal to the control unit, whereupon the control unit can control the cooling agent providing device 109 to stop providing the cooling agent to the portion of the belt conveyor 101 corresponding the nozzle bundle. Thus, when there is no nozzle bundle and no filaments are fed onto the belt conveyor, the suitable amount of the cooling agent is provided to the portion corresponding the nozzle bundle to keep the heat transfer from the belt conveyor 101 to the cooling agent essentially at the same level than if there would be full load of filaments from the nozzle bundle. Again, when the nozzle bundle is set and the providing of the cooling agent is stopped, the filaments from the bundle set will absorbs as much heat from the belt conveyor 101 than the cooling agent and thus the system is kept equilibrium and the temperature of the belt conveyor 101 essentially unchanged. The second detecting device 116 may comprises e.g. an inductive sensor, a limit switch or the like detecting the existence of the nozzle bundle.

The arrangement may also comprise a temperature measuring device 117 for measuring temperature of different portions of the belt conveyor and input the measured data to the control unit so that the control unit can control the cooling agent providing devices 109 to provide cooling agent 119 to those portions, where the temperature is rising, expected to be risen or is already higher than should be. For example, in FIG. 6 the temperature measuring device 117 may measure temperature of the lines 105A, 105B, 105C in different the portions 110, 111 of the belt conveyor 101. If the temperature measuring device 117 determines that the temperature in one first portion 110 of the one first line 105A is increasing over a predetermined limit or is higher than the temperature in at least one second portion 111 of the one first line 105A or than the temperature of the second line 105B (e.g. a reference line or next to the first line or locating symmetrically opposite the longitudinal axis 113) in said first portion 110 or the temperature of at least one first portion 110 of the one first line 105A deviates (being higher) from a predetermined value, the control unit 114 is, based on said temperature data, configured to control at least one of the cooling agent providing device 109B to provide and/or adjust the cooling agent 119 to at least said one first portion 110 of said at least one first line 105A of the belt conveyor 101 to control the temperature profile of the belt conveyor 101 in the predetermined manner. It is to be noted that the nozzles (or the nozzle bundle) 104A operates well and feeds 100% load of filaments onto the belt conveyor 101, whereupon there is no need to activate the cooling agent providing device 109A to provide the cooling agent 119 to those portions of the belt conveyor 101 corresponding the feed of the nozzles (or the nozzle bundle) 104A.

The arrangements may also comprise a further processing device 120, such as a winding device 120 for winding the dried filaments.

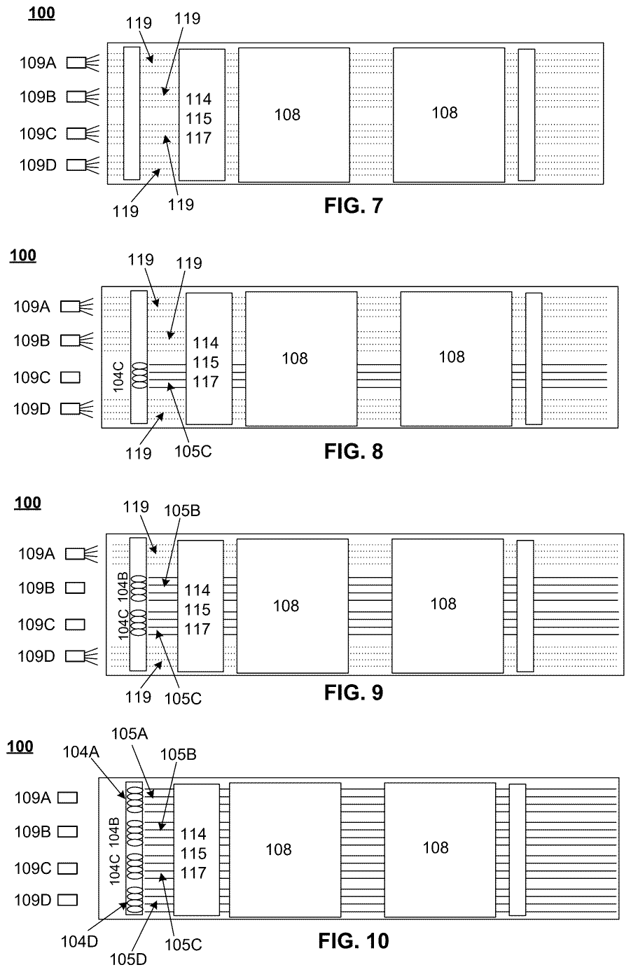

FIGS. 7-10 illustrate an example view of an initialization and start up process of an exemplary transferring device 101 according to an advantageous embodiment of the invention, where the transferring device is the belt conveyor 101 and the nozzles providing material, such as filaments, are arranged to the nozzle bundles 104A, 104B, 104C, 104D. In FIG. 7 the arrangement is initialized so e.g. the temperature of the belt conveyor is already set to a desired level, which is also used in the process of transferring and hearing and/or drying the filaments. In FIG. 7 there is no nozzle bundles 104A, 104B, 104C, 104D set yet, and there are no material or filaments of the belt conveyor 101. In addition, all the cooling agent providing devices 109A, 109B, 109C, 109D are providing cooling agent 119 to all lines 105A, 105B, 105C, 105D.

In FIG. 8 one of the nozzle bundles 104C is set and it provides the filaments on the line 105C of the belt conveyor 101. At the same when the filaments are started to receive to the surface of the belt conveyor 101 from the nozzle bundle 104C, the cooling agent providing device 109C is stopped, or in other words, cooling agent 119 is stopped to be provided to the lines 105C which are now receiving the filaments from the nozzle bundle 104C.

In addition, In FIG. 9 the next nozzle bundle 104B is set, whereupon it starts to provide the filaments on the line 105B of the belt conveyor 101. At the same when the filaments are started to receive to the surface of the belt conveyor 101 from the nozzle bundle 104B, the cooling agent providing device 109B is stopped, or in other words, cooling agent 119 is stopped to be provided to the lines 105B which are now receiving the filaments from the nozzle bundle 104B.

The same continues until all the nozzle bundles 104A, 104B, 104C, 104D are set, when also all the cooling agent providing devices 109A, 109B, 109C, 109D are stopped, as is the case in FIG. 10.

FIG. 11 illustrate a principle of another exemplary arrangement 100 for controlling a temperature profile of a transferring device according to an advantageous embodiment of the invention, where the transferrin device is a rotating cylinder 101, which receives material 102 to its outer surface and transfers the material via rotational movement from the input area 103 to the output area 106 and possibly again to a further processing, such as dried filaments to a winding device 120. It is to be noted that the rotating cylinder 101 is such an example of the transferring device, and all the other embodiments and devices illustrated and discussed in connection with the belt conveyor 101, such as the control unit 114, the cooling agent providing devices 109, and the devices for measuring temperature 117 of the transferring device or material received/transferred, or the devices 115, 116 for determining amount or existence of material or nozzles or nozzle bundles, can also be used with the rotating cylinder.

It is to be noted that the belt conveyor and the rotating cylinder are illustrated now as the examples of the transferring device, but the invention can be implemented also with other types of transferring device, such as devices having a moving or rotating surface, which is configured to receive the material, so e.g. the filaments, and transfer, heat and/or dry it/them.

The invention has been explained above with reference to the aforementioned embodiments, and several advantages of the invention have been demonstrated. It is clear that the above mentioned structures, devices, components and arrangements are only examples, and that the invention is not only restricted to these specific embodiments. For example, even if the filaments, nozzles, and belt conveyors are illustrated in connection with the Figures, they are just examples of the materials, output devices and transferring devices.

Typically, the situation is that the temperature profile is to be kept constant or unchanged, but the invention is however not limited to that but also some other temperature profile can be achieved and maintained. For example, the temperature profile may be controlled to so that a certain portion, such as an edge portion of the belt conveyor for example, is cooler than other portions of the belt conveyor, whereupon the edge portion of the belt conveyor will shrink due to the heat shrinkage and the belt conveyor can be drifted in a controlled manner towards the higher temperature side of the belt conveyor.

The features recited in dependent claims are mutually freely combinable unless otherwise explicitly stated.

1. An arrangement for controlling a temperature profile of a transferring device,
wherein the transferring device is configured to receive material to an input area of the transferring device from a material output and transfer the material in multiple lines from the input area to an output area of the transferring device in a first direction,
wherein:
the material is configured to be heated so to provide drying of the material during the transportation,
the arrangement comprises at least one cooling agent providing device to provide the cooling agent on a surface of the transferring device, and
wherein
the arrangement is configured to provide said cooling agent to at least one first portion of at least one first line of the transferring device, said one first portion of said one first line having no material or having less material than at least one second portion of said at least one first or one second line or temperature of said one first portion being higher or expected to increase higher than temperature at least one second portion of said at least one first or one second line, in order to control the temperature profile of the transferring device in a predetermined manner.

2. An arrangement according to claim 1, wherein at least one of the cooling agent providing devices is configured to provide said cooling agent to said at least one first portion of at least one first line of the transferring device at said input area, between said input and output areas, before said input area and/or after said output area in said first direction.

3. An arrangement according to claim 1, wherein the arrangement is configured to control the temperature profile of the transferring device in said first direction of the transferring device and/or in a second direction of the transferring device, said second direction being perpendicular to said first direction of the transferring device.

4. An arrangement according to claim 1, wherein said at least one second line is next to said one first line or a line locating opposite to a longitudinal center line between said input and output areas of the transferring device or a reference line for which a heat delivery to the material corresponding to a full reception of material amount is determined.

5. An arrangement according to claim 1, wherein the transferring device comprises a belt conveyor, such as a metal coated belt conveyor or a rotating cylinder, an outer surface of which is configured to be faced against the material to be received in the input area of the transferring device, whereupon the one first portion of the one first or second line of the transferring device is a certain length of the endless loop of the transferring device or the entire loop of the transferring device.

6. An arrangement according to claim 1, wherein the material is configured to be heated by heating devices from above the transferring device or via the outer surface of the transferring device which is configured to be heated to a higher temperature than the temperature of the material to be received in order to achieve drying effect to the material by the surface of the transferring device.

7. An arrangement according to claim 1, wherein the arrangement is configured to control a mass flow and/or temperature of the cooling agent provided by the cooling agent providing device to the surface of the transferring device so to cause a desired heat transfer from the transferring device to the cooling agent in order to control the temperature profile of the transferring device in a predetermined manner.

8. An arrangement according to claim 7, wherein the arrangement is configured to control quantity and/or temperature of the cooling agent provided by the cooling agent providing device to the one first portion of the one first line of the transferring device with no or less than full load of the material so that the total heat transfer from said one first portion of the one first line is essentially equal to heat transfer that would be with just the full load of material from the one first portion of the one first line of the transferring device.

9. An arrangement according to claim 7, wherein the arrangement is configured to control quantity and/or temperature of the cooling agent provided by the cooling agent providing device to the one first portion of the one first line of the transferring device with no or less than full load of the material so that the total heat transfer from said one first portion of the one first line is essentially equal to heat transfer of said at least one second portion of said one first or second line.

10. An arrangement according to claim 1, wherein at least one of the cooling agent providing devices is configured to provide said cooling agent to an outer surface of the transferring device and/or to an inner surface of the transferring device, said inner surface locating opposite side of the transferring device than said outer side.

11. An arrangement according to claim 1, wherein the material output comprises nozzles configured to output said material onto the transferring device and wherein the nozzles are set in a number of nozzle bundles, whereupon the one nozzle bundle comprising number of nozzles is configured to provide material to the input area of the transferring device.

12. An arrangement according to claim 1, wherein the arrangement comprises a control unit and a first detecting device for detecting an existence or amount of the material in said multiple lines on the transferring device and based on the detection outputting data related to said detected existence or amount of the material in said multiple lines to the control unit, whereupon the control unit is, based on said data, configured to control at least one of said cooling agent providing device to provide and/or adjust the cooling agent to at least one first portion of said at least one first line of the transferring device, when there is detected a lack of material on said at least one first portion of said at least one first line of the transferring device.

13. The arrangement according to claim 11, further comprising a control unit and a second detecting device for detecting an existence of the nozzle bundle and outputting data relating to the existence of said nozzle bundle to the control unit, whereupon the control unit is, based on said data, configured to control at least one of said cooling agent providing device to provide and/or adjust the cooling agent to at least one first portion of said at least one first line of the transferring device in the case the nozzle bundle is not detected, where said at least one first line corresponds to lines provided by said nozzle bundle.

14. An arrangement according to claim 1, wherein the arrangement comprises a control unit and a temperature measuring device for measuring temperature of at least one first portion of said at least one first line of the transferring device, and if the temperature measuring device determines that the temperature in at least one first portion of said at least one first line is increasing over a predetermined limit or is higher than the temperature in at least one second portion of said at least one first or second line or the temperature of at least one first portion (110) of said at least one first line deviates from a predetermined value, the control unit is, based on said temperature data, configured to control at least one of said cooling agent providing device to provide and/or adjust the cooling agent to at least said one first portion of said at least one first line of the transferring device to control the temperature profile of the transferring device in the predetermined manner.

15. An arrangement according to claim 1, wherein the cooling agent providing device is a spraying device for spraying water, water based substance, chemical active ingredient, air, liquid nitrogen or other coolant or fluid having a cooling effect and/or release chemical having a friction changing effect for structural parts of the transferring device or between the transferring device and the material transferred.

16. A method for controlling a temperature profile of a transferring device, wherein the method comprises:
receiving material to an input area of a transferring device from material output and transferring the material in multiple lines from the input area to an output area of the transferring device in a first direction,
heating and drying the material during the transportation,
providing cooling agent on a surface of the transferring device by at least one cooling agent providing device, and
providing said cooling agent to at least one first portion of at least one first line of the transferring device, where said one first portion of said one first line does not have material or has less material than at least one second portion of said at least one first or one second line or temperature of at least one first line of at least one first portion being higher or expected to be higher than temperature of said at least one first or one second line of at least one second portion, in order to control the temperature profile of the transferring device in a predetermined manner.

17. A method according to claim 16, wherein the temperature profile is controlled in said first direction of the transferring device and/or in a second direction of the transferring device, said second direction being perpendicular to said first direction and along the surface of the transferring device.

18. A method according to claim 16, wherein the temperature profile is controlled to be essentially constant, so that a gradient of the temperature profile is essentially zero, or to changing according with the predetermined manner in said first and/or second directions.

19. A method according to claim 18, wherein the gradient of the temperature profile is controlled to deviate from zero in said second direction in order to guide a belt like transferring device towards a higher temperature side of the belt; or wherein the gradient of the temperature profile is controlled to deviate from zero locally in said first direction to shrink the belt of the belt like transferring device locally to loosen the material easier from the surface of the belt of the belt like transferring device.
